(19) United States
(12) Patent Application Publication
(10) Pub. No.: US 2018/0060943 A1
(43) Pub. Date: Mar. 1, 2018

(54) APPARATUS AND METHOD FOR MANAGEMENT OF A HYBRID STORE

(71) Applicant: Wal-Mart Stores, Inc., Bentonville, AR (US)

(72) Inventors: Todd D. Mattingly, Bentonville, AR (US); Nathan G. Jones, Bentonville, AR (US)

(21) Appl. No.: 15/685,981

(22) Filed: Aug. 24, 2017

Related U.S. Application Data
(60) Provisional application No. 62/380,036, filed on Aug. 26, 2016.
(60) Provisional application No. 62/436,842, filed on Dec. 20, 2016.
(60) Provisional application No. 62/485,045, filed on Apr. 13, 2017.
(60) Provisional application No. 62/510,317, filed on May 24, 2017.

(51) Int. Cl. G06Q 30/06; G06Q 10/08; G06Q 20/20; G06Q 30/02

(52) U.S. Cl. CPC G06Q 30/0639; G06Q 30/02; G06Q 20/20; G06Q 10/087

(57) ABSTRACT

Systems, apparatuses, and methods are provided herein for store management. A store management system comprises a product allocation database storing product location indicators for one or more unique product identifiers associated with items offered for sale, an item consolidation system, a retail space stocking system, and a control circuit. The control circuit being configured to: determine whether to place an item on a retail space accessible to customers or in a storage area, instruct the retail space stocking system to stock the retail space based on the product location indicator of a plurality of items, receive an order from an in-store customer including a plurality of selected items that comprises items not available in the retail space, and cause the item consolidation system to retrieve at least some of the items not available on the retail space from the storage area for the in-store customer.

### RELATED APPLICATION(S)

This application claims the benefit of U.S. Provisional application No. 62/436,842, filed Dec. 20, 2016, and U.S. Provisional application No. 62/485,045, filed Apr. 13, 2017, U.S. Provisional application No. 62/380,036 filed Aug. 26, 2016, and U.S. Provisional application No. 62/510,317 filed May 24, 2017 which are all incorporated by reference in their entirety herein.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

Traditional brick-and-mortar stores typically place items offered for sale out on the sales floors. In-store customers shop by selecting items off the shelves on the sales floor and bringing items to a checkout counter to make a purchase.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises a block diagram of a system as configured in accordance with various embodiments of these teachings;

FIG. 19 comprises a flow diagram of a method as configured in accordance with various embodiments of these teachings;

FIG. 20 comprises an illustration of a modular unit as configured in accordance with various embodiments of these teachings;

FIG. 21 comprises an illustration of a store in accordance with several embodiments;

FIG. 22 comprises a block diagram as configured in accordance with various embodiments of these teachings;

FIG. 23 comprises a flow diagram as configured in accordance with various embodiments of these teachings; and

FIG. 24 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

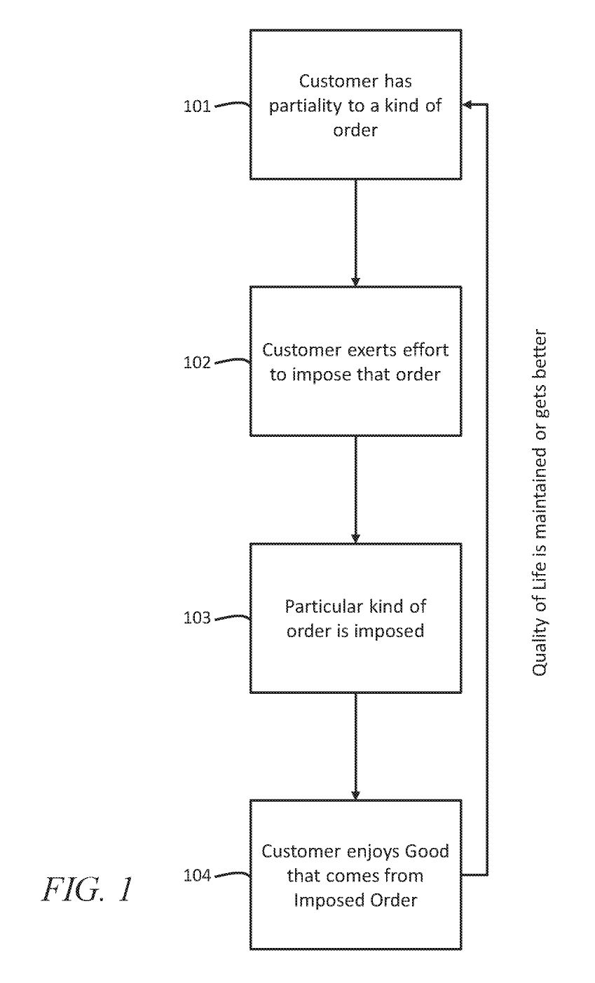

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

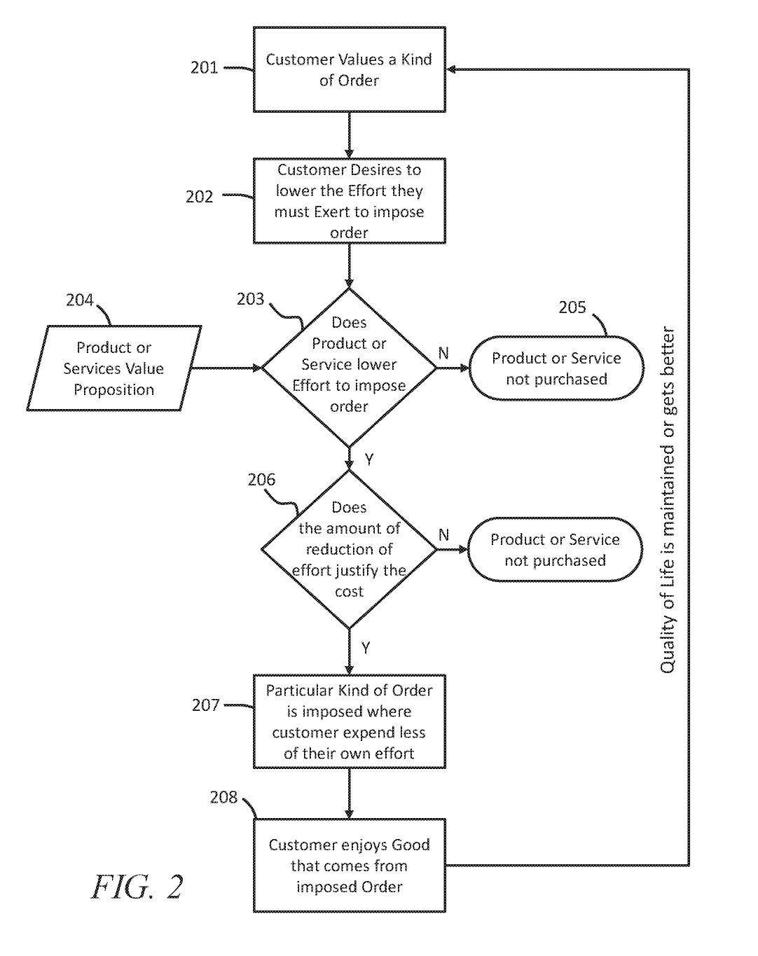

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

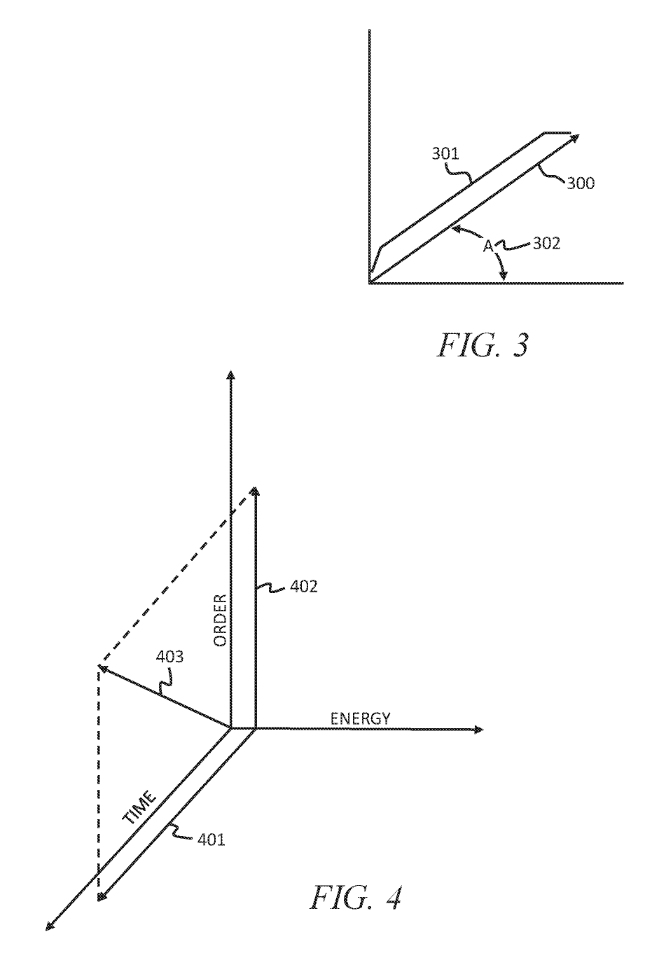

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

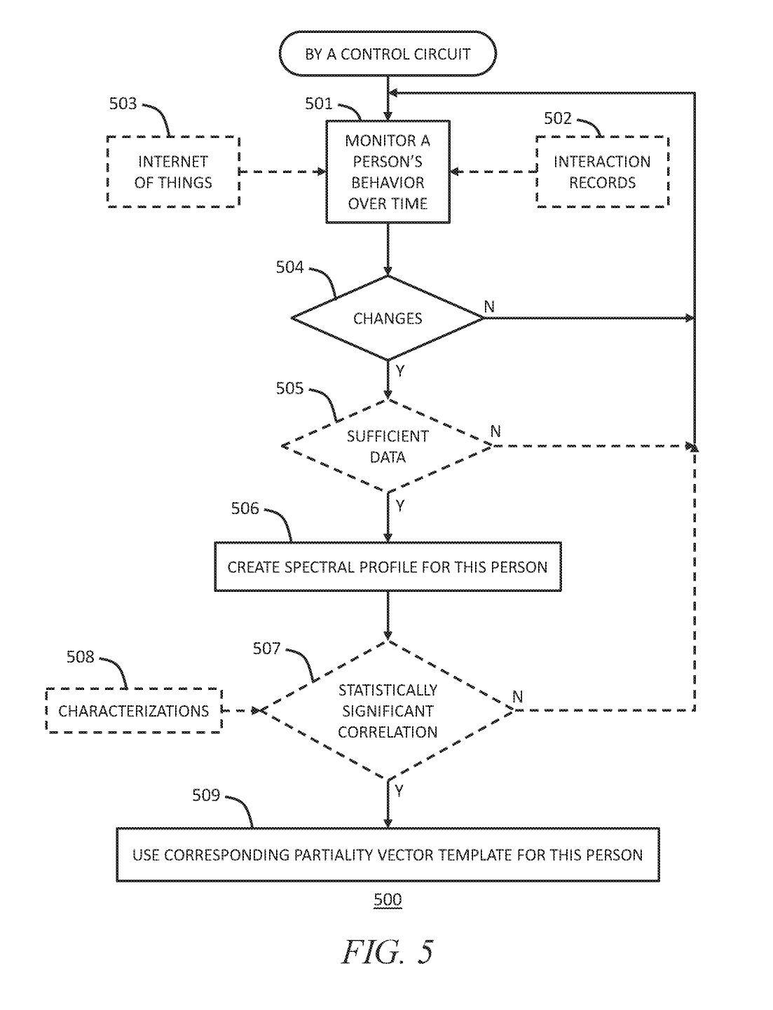

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

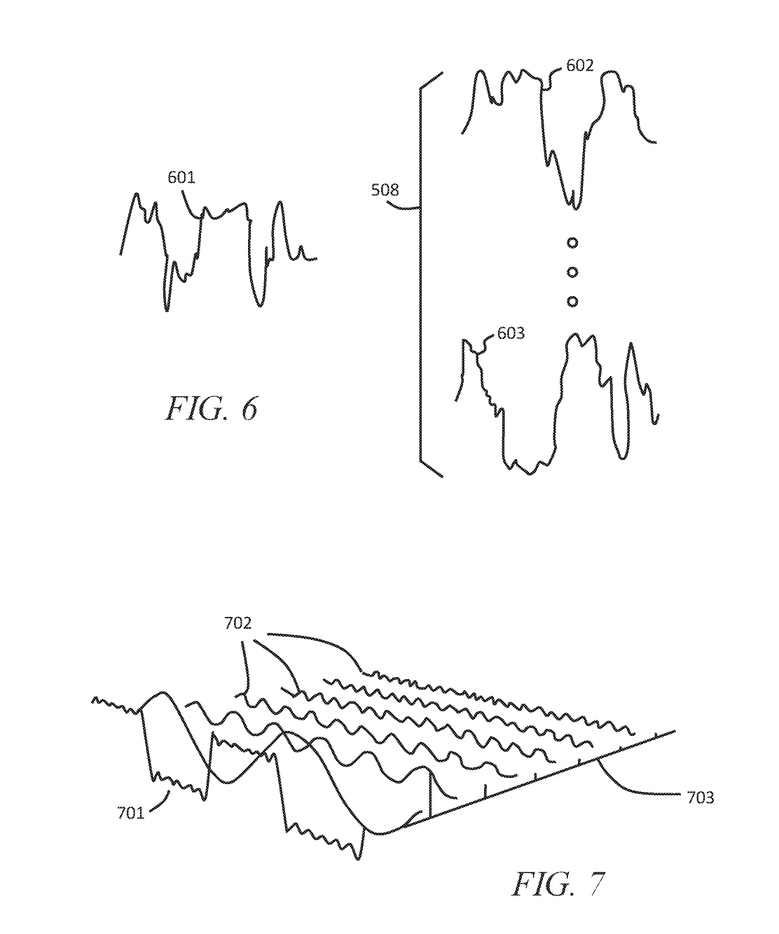

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

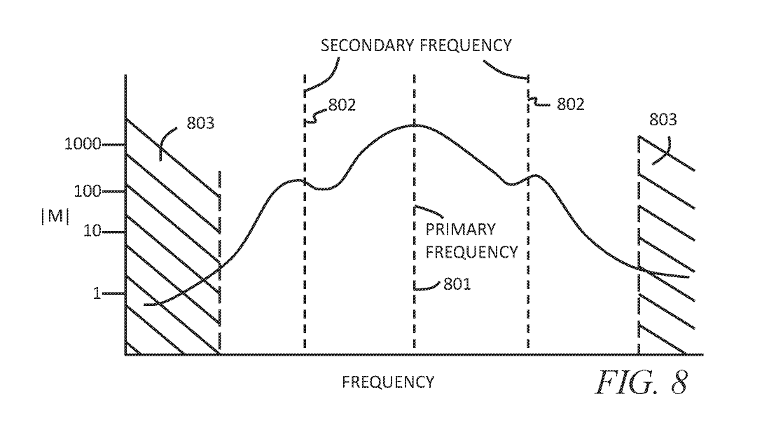

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

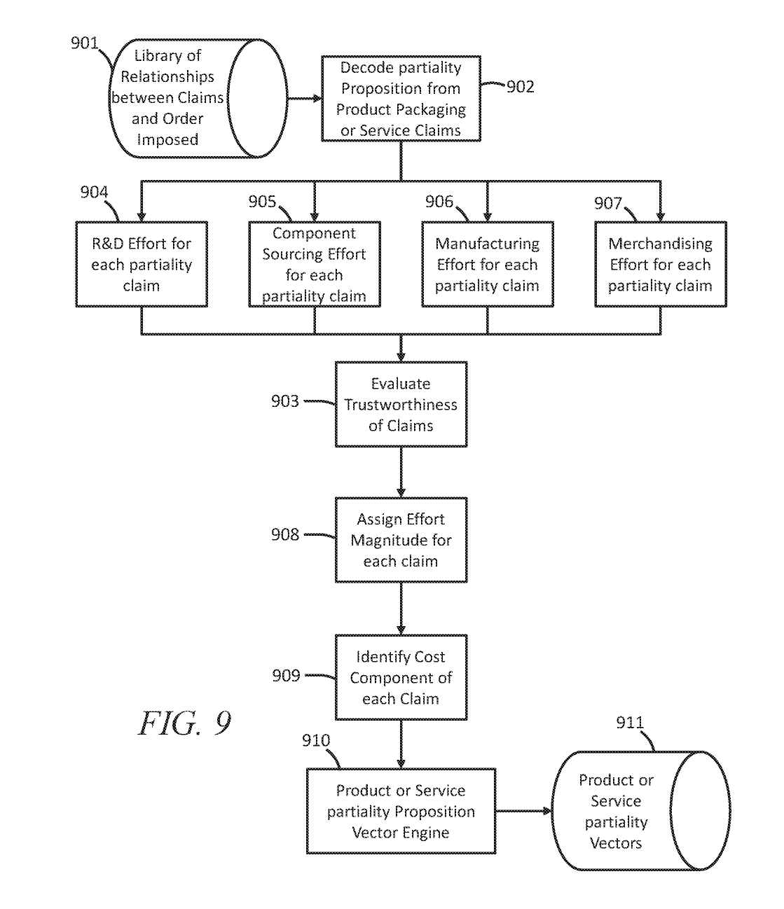

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

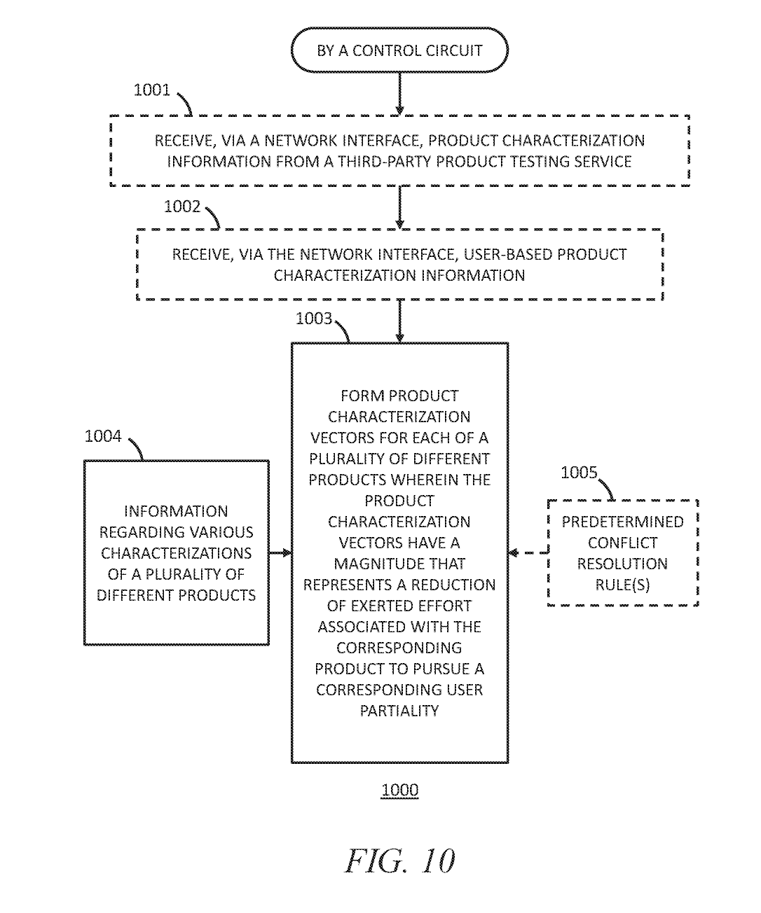

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

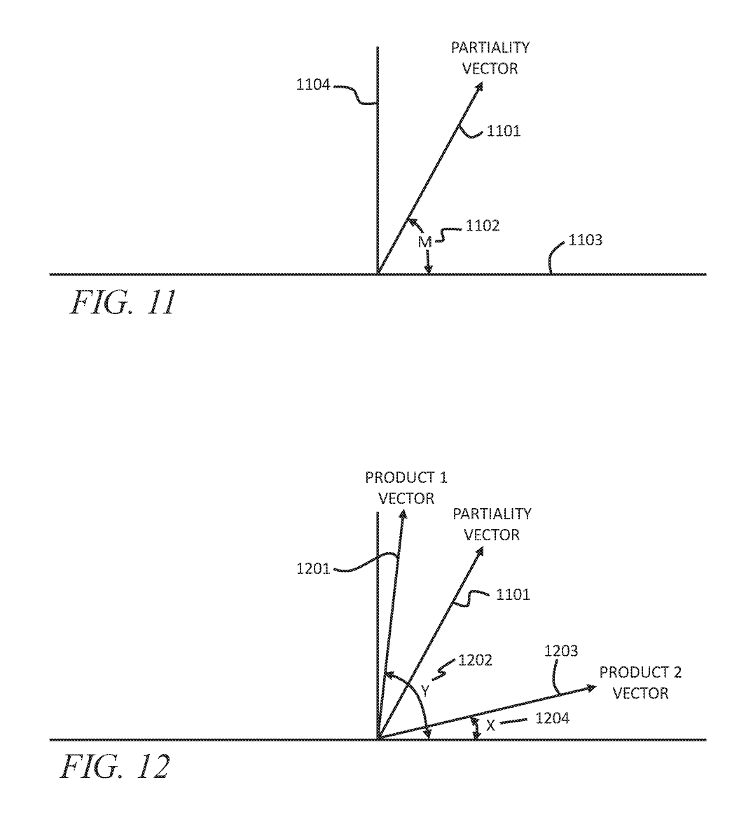

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

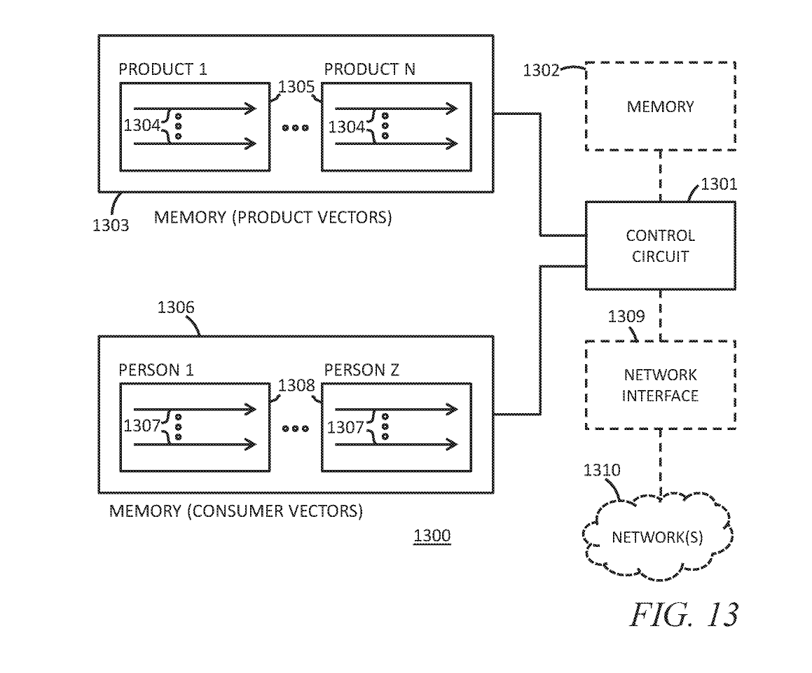

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

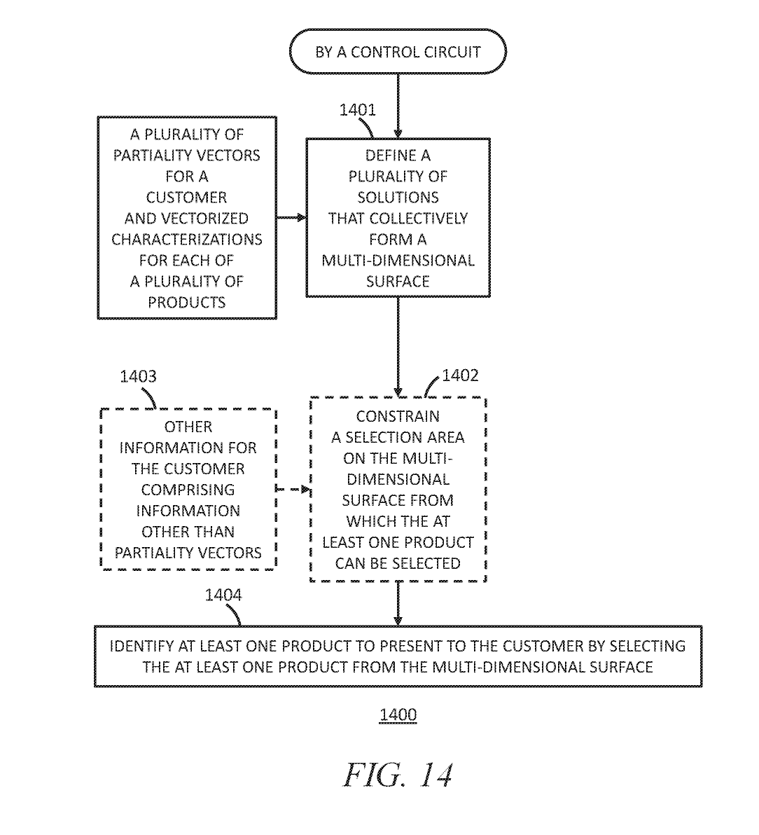

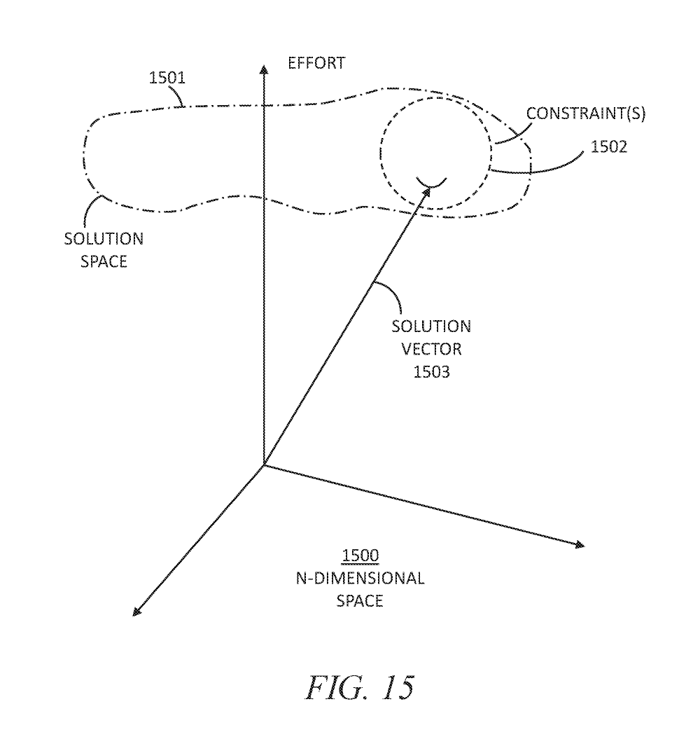

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

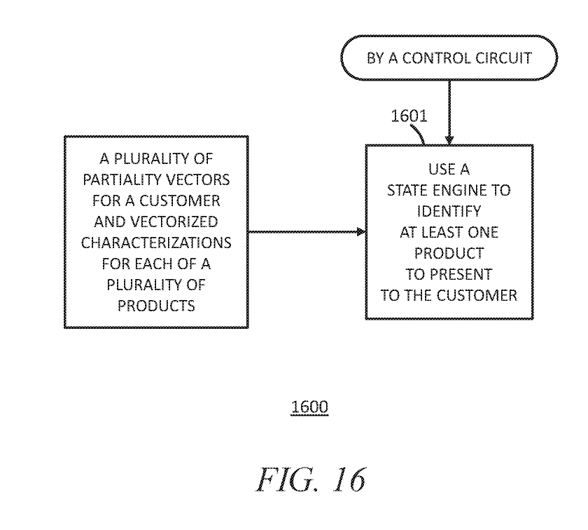

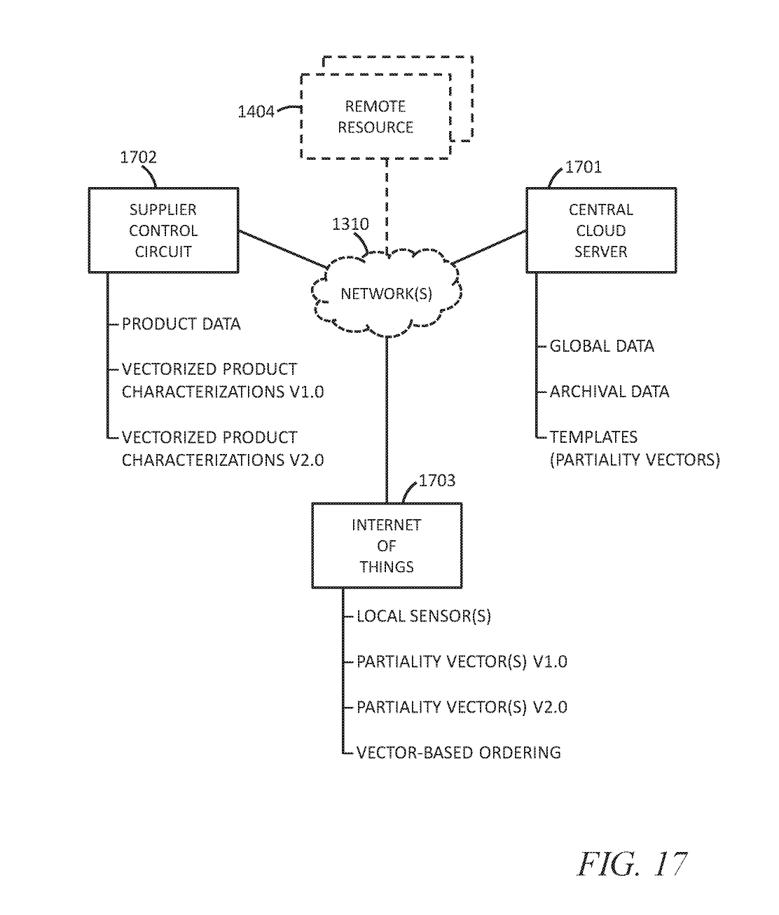

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Generally speaking, pursuant to various embodiments, systems, apparatuses and methods are provided herein for store management. In some embodiments, a store management system comprises a product allocation database storing product location indicators for one or more unique product identifiers associated with items offered for sale, an item consolidation system, a retail space stocking system, and a control circuit coupled to the product allocation database, the item consolidation system, and the retail space stocking system. The control circuit being configured to: determine whether to place an item on a retail space accessible to customers or in a storage area inaccessible to the customers based on a product location indicator associated with the item, instruct the retail space stocking system to stock the retail space based on the product location indicator of a plurality of items, receive, via a user interface, an order from an in-store customer including a plurality of selected items that comprises items not available in the retail space, and cause the item consolidation system to retrieve at least some of the items not available on the retail space from the storage area for the in-store customer.

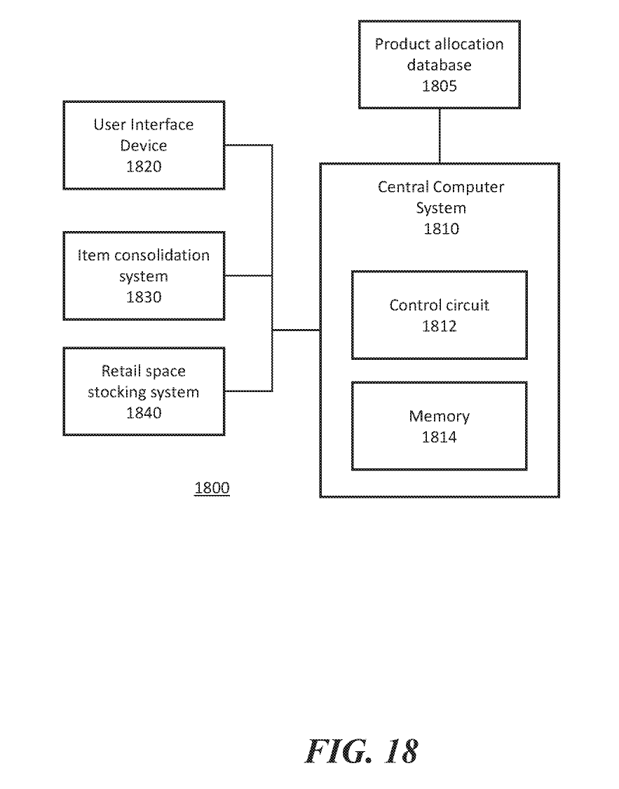

Referring now to FIG. 18, a system for store management is shown. The system 1800 includes a central computer system 1810 coupled to a product allocation database 1805, a user interface device 1820, an item consolidation system 1830, and a retail space stocking system 1840.

The central computer system 1810 comprises a control circuit 1812 and a memory 1814. The central computer system 1810 may comprise one or more of a remote server, a local computing system, a store management computer system, and the like. The central computer system 1810 may be configured to manage a shopping facility comprising at least a retail space accessible to customers and a storage area generally inaccessible to customers. In some embodiments, the shopping facility may comprise a hybrid distribution center and retail store format in which items displayed in the retail space of the shopping facility are dynamically determined and a customer may purchase items directly from the retail space or order items from the storage area located in the same shopping facility. In some embodiments, the central computer system 1810 may further be configured to manage a plurality of shopping facilities and/or delivery order fulfillment centers.

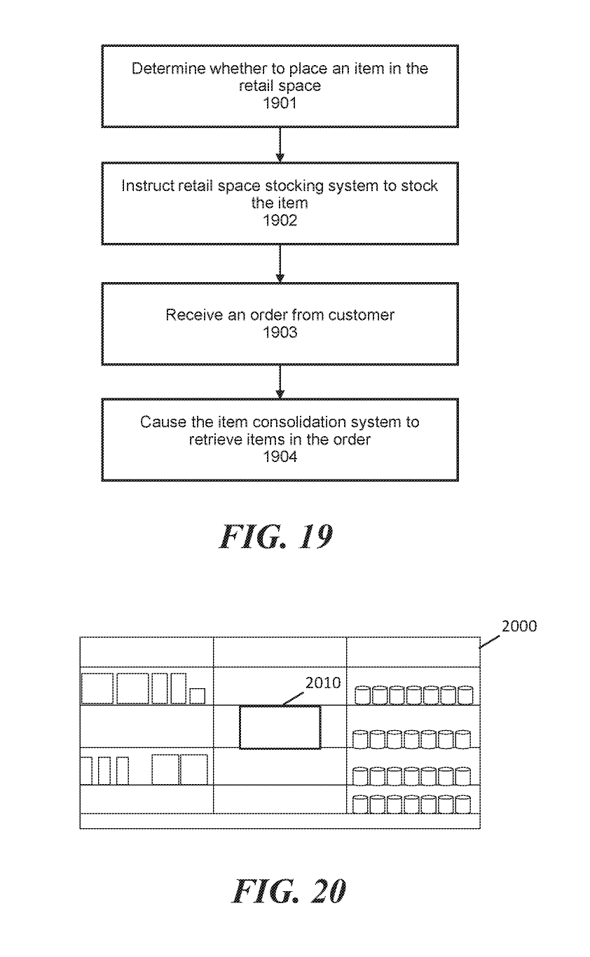

The control circuit 1812 may comprise a processor, a microprocessor, and the like and may be configured to execute computer readable instructions stored on a computer readable storage memory 1814. The computer readable storage memory 1814 may comprise volatile and/or non-volatile memory and have stored upon it, a set of computer readable instructions which, when executed by the control circuit 1812, causes the central computer system 1810 to manage a shopping facility and process customer orders via one or more of the item consolidation system 1830, the retail space stocking system 1840, and the user interface device 1820. In some embodiments, the computer executable instructions may cause the control circuit 1812 of the central computer system 1810 to perform one or more steps in the methods described with reference to FIG. 19 herein.

The product allocation database 1805 may comprise computer readable memory configured to store product allocation information. In some embodiments, the product allocation database 1805 stores product location indicators assigned to one or more unique product identifiers associated with items offered for sale. In some embodiments, the product allocation database 1805 may comprise specialized database structure for associating unique product identifiers with item location indicators. In some embodiments, the unique product identifiers may comprise one or more of a Universal Product Code (UPC), a Barcode, a Radio Frequency Identification (RFID) code, a product name, a product descriptor, a retailer assigned product identifier, etc. In some embodiments, unique product identifiers associated with different color, size, flavor, and/or scent variants of a product type may be assigned different product location indicators. In some embodiments, the product location indicators for the one or more unique product identifiers may comprises a status selected from: display in retail space, hold in storage area only, and online order only. For example, the system may specify that unscented A brand shampoo should be displayed in the shopping space, citrus scented A brand shampoo should be held in the storage area only, and cucumber scented A brand shampoo may be online order only. In another example, an item allocation database may specify only medium size white t-shirts of a particular t-shirt design should be made available in the retail space, sizes XS, S, L, and XL of the same t-shirt and the blue version of the same t-shirt be held in the storage area, and all other sizes and colors of the t-shirt should be online order only items. In some embodiments, an item assigned with a “display in retail space” location indicator may also have excess unites of the item stored in the storage area and be available for purchase through online orders. In some embodiments, an item assigned with a “hold in storage area only” location indicator may also be available for purchase through online orders. In some embodiments, “online order only” items may be ordered for delivery and/or in-store pickup at a later date. Generally, “storage area only” and “online order only” items are not made available for retrieval and purchase from the retail space of a store location.

In some embodiments, the product location indicators in the product allocation database may be dynamically updated based on one or more of: sales trend, sales history, store location demographic, promotions, product characteristics, current date, current season, and current weather. In some embodiments, the product location indicators may be determined based on comparing partiality vectors of the customers in the store location's market and vectorized product characteristics of a plurality of products offered for sale. For example, customer partiality vectors and vectorized product characteristics may be used to estimate/predict the purchase rate of one or more products at the store location. Further descriptions of customer partiality vectors and vectorized product characteristics are provided with reference to FIGS. 5-10 here.

In some embodiments, product location indicators associated with each unique product identifier may be updated independently of each other. For example, based on sales history, the system may change the allocation of a particular item and/or an variant of a product (e.g. raspberry flavored chocolate, B brand size 4 blue tennis shoes) from the storage area to the retail space or vice versa. In some embodiments, the system may similarly determine whether the stock an item or a variant of an item at a store location. In some embodiments, the allocation of an item may be determined based on past or predicted sales rate of an item at a store location. For example, unique product identifiers associated with items with the highest sales rates (e.g. units of items sold per day) may be assigned a “display in the retail space” product location indicator, items with moderate sales rates may be assigned a “storage area only” product location indicator, and items that are rarely purchased at a store location may be assigned a “order only” product location indicator. In some embodiments, products may be compared to products in the same type or category to determine each product's allocation. In some embodiment, products assigned to each location indicator may be further based the available display space and/or storage space in the shopping facility. For example, if the display area of the retail space assigned to display coffee products can display ten different types of coffee, the system may select the top ten most popular types of coffee products to display in the retail space. In some embodiments, product allocations may be determine store-wide across and the retail space sections assigned to different product types and/or categories may be adjusted accordingly. For example, if a store location sells a lot more coffee as compared to tea, the size of the display area allocated to tea products may be reduced and the coffee product display area may be expanded.

In some embodiments, the product location indicators for each unique product identifier may further specific the target quantity of each item at one or more locations. For example, the product allocation database 1805 may specify that twenty units of C brand hazelnut coffee and thirty unites of C brand French roast coffee should be placed in the retail space. In another example, the product allocation database 1805 may specify that twenty units of C brand hazelnut coffee should be placed in the retail space while fifty units of the C brand hazelnut coffee should be kept in the storage area. In some embodiments, the system may cause items in the retail space to be replenished from the items from the storage area if the inventory level in the retail space falls below the retail area target quantity. In some embodiments, the system may causes items to be ordered for a store location if the item quantity in the storage area falls below the storage area target quantity. In some embodiments, the quantities of each item at one or more locations may be determine based on one or more of sales trend, sales history, store location demographic, product characteristics, promotions, current date, current season, and current weather. In some embodiments, the product location indicator may be store location specific and determined on a store-by-store and/or region-by-region basis. For example, the system may specific that twenty units of C brand hazelnut coffee should be placed in the retail space at store location X while no units should be placed in the retail space at store location Y. In some embodiments, product location indicators for a plurality of unique product identifiers in the product allocation database 1805 may be dynamically updated by the central computer system 1810 and/or another product allocation system. The determination may further be made for each individual store location based on the sales data and/or customer characteristics associated with the store location.

The user interface device 1820 comprises a processor-based device configured to allow a customer to order items. In some embodiments, the user interface device 1820 may comprise one or more ordering kiosk in the retail space. In some embodiments, the user interface device 1820 may comprise portable network-connected devices provided by the shopping facility and/or belonging to a customer. In some embodiments, the user interface device 1802 may comprise one or more of a touch screen display, a projection display device, an augmented reality display device, and a virtual reality display device. The user interface device 1820 may comprise a user interface for an in-store customer to select one or more items to order. In d embodiment, the product ordering user interface may comprise one or more of a computer program and a mobile application. An in-store customer may first browse items on display modules in a retail space. If an item is available in the retail space, the customer may retrieve the item off the shelf, place the item in a shopping cart or basket, and carry the item to checkout. If the item the customer wishes to purchase (e.g. size 6 Brand E blue jeans) is not made available in the retail space, the customer may use the user interface device 1820 order the item from the storage area of the shopping facility or from a remote distribution and/or fulfillment center. In some embodiments, the system may associate a customer with the order by prompting the customer to log-in to the system, enter a customer ID, scan a customer loyalty card, scan a customer bank card, etc. The customer may then select an item via the user interface displayed on the user interface device 1820 to add to their personal virtual shopping cart. In some embodiments, the customer may scan a UPC or barcode on an item from the retail space at the user interface device 1820, and the user interface may display related items to the customer. For example, if the customer scans in a pair of size 6 Brand E blue jeans, the system may show the same blue jeans in different sizes, the same style of jeans in different colors, other types of pants from the same brand, similar blue jeans, etc. In some embodiments, the user interface device 1820 may be configured to initially display items associated with the in-store location of the user interface device 1820 and/or the customer. For example, for a stationary kiosk type user interface device 1820 located in the canned food section, the user interface may initially display different types of canned food offered for sale to the customer. In some embodiments the user interface device 1820 may initially only display or prioritize the display of items that are available at the local store location. In some embodiments, the user interface device 1820 may allow the customer to browse products associated with other sections of the store and/or items available only through online order. A customer may then select one or more products to add to a virtual shopping cart associated with the customer. In some embodiments, the virtual shopping cart may include items the customer intends to retrieve from the retail space, receive from the storage area, and/or order from a remote distribution center.

In some embodiments, the user interface device 1820 may indicate whether each item is available in the retail space, available in the storage area of the shopping facility, and/or available via online order only. For example, the user interface may include an icon next to each displayed product to indicate to the user the available purchase methods associated with each item. In some embodiments, the available purchase methods may be determined based on the product location indicator stored in the product allocation database 1805 and/or the item's current availability in the retail space and/or the storage space of the local store location. In some embodiments, the system may provide the customer with the option to receive products available on the retail space from the storage space if the customer prefers to not carry the product around the store while he/she shops. In some embodiments, the system may provide the customer with the option to deliver products available in the retail space and/or in the storage area of the shopping space to a customer specified off-site location if the customer prefers to not transport the products themselves. In some embodiments, the user interface may provide one or more purchase methods for one or more items in a customer's virtual shopping cart. In some embodiments, one or more methods may be selected individually for each items in the shopping cart and/or for the entire shopping cart. In some embodiments, the customer may purchase items accessible to the customers in the retail space through conventional methods without adding the item to the virtual shopping cart via the user interface device 1820. In some embodiments, the user interface displayed on the user interface device 1820 may further provide customization options for one or more items. The customization of an order product may be carried out by a customization system in the storage area of the shopping facility, in a remote distribution center, and/or by a supplier of the item. In some embodiments, the customization options may comprise one or more of printing, 3D printing, engraving, and tailoring.

The item consolidation system 1830 may comprise a consolidation system in the storage area of a shopping facility configured to consolidate stored items for customer retrieval. In some embodiments, the item consolidation system 1830 may comprise mechanisms such as one or more of an automated conveyor system, conveyor belts mechanical arms, and motorized movable units for moving items from storage spaces to an item collection area for customer retrieval. In some embodiments, the item consolidation system 1830 may comprise one or more associate user devices configured display consolidation instructions to one or more store associates. For example, the system may cause an associate user device may instruct an associate to “bring 2 count C brand hazelnut coffee—32 oz at aisle 6, slot 5B to customer tote #32.” In some embodiments, the item consolidation system 1830 may comprise a processor-based computer system configured to convert storage area orders received from the central computer system 1810 to instructions for an automated conveyor system, a conveyor belt system, a movable transport unit system, and/or store associates of the item consolidation system 1830. In some embodiments, the instructions may be based on an item storage location database associated with the storage area of the item consolidation system 1830. In some embodiments, if an item is available in the retail space but not in the storage area, the system may instruct an associate and/or a movable transport unit to bring the item from the retail space to the storage area for consolidation. In some embodiments, the item consolidation system 1830 may be configured to place the plurality of items in a container for customer pickup or delivery. For example, items may be consolidated into a pick-up tote, a shipment box, a delivery cooler, etc. for the customer. In some embodiments, the items consolidated by the item consolidation system 1830 may be configured to be picked up by the customer at the store location, delivery directly from the shopping facility to the customer location, and/or shipped via a third party delivery service provider. In some embodiments, the item consolidation system 1830 may be configured to consolidate items ordered by a customer while the customer is in the store such that the items are ready for customer pickup shortly after the customer has selected all items he/she wish to purchase. In some embodiments, the item consolidation system 1830 may further be configured to retrieve and consolidate items from the storage area to restock the retail space and transfer the items the retail space stocking system 1840 for restocking.

In some embodiments, the item consolidation system 1830 may be coupled to a customization system configured to customize one or more products for a customer prior to providing the product to the customer. In some embodiments, the item consolidation system 1830 may be configured to transport items to and/or from the customization system. In some embodiments, the customization system may be configured to provide product customization of products comprising one or more of printing, 3D printing, engraving, and tailoring. For example, for a particular pair of pants, the storage area may only store pants with 36-inch inseams. When a 34-inch inseam pair of paints is ordered, the item consolidation system may bring a pair of pants to the customization system to be hemmed to the length of 34 inches. In another example, the storage area may store t-shirts with different sizes or colors without printed designed. When a t-shirt with a particular design is ordered by a customer, the consolidation system may bring a plain t-shirt matching the ordered size and color to the customization system to be screen printed with the selected design prior to providing the item to the customer. In some embodiments, the customizations may be presented to the customer as options (e.g. text to engrave, design variations) selectable for a product. In some embodiments, one or more products may be presented as regular products (e.g. 32×34 pants, yellow t-shirt with star design, etc.) to customers, and the customization system may modify a more generic product (e.g. unhemmed pants, plain t-shirts, etc.) to produce the ordered product in the shopping facility.

The retail space stocking system 1840 may comprise a system for stocking the retail space of a shopping facility that is accessible to customers shopping in the shopping facility. In some embodiments, the retail space stocking system 1840 may further monitor the current stock levels of a plurality of items in the retail space. In some embodiments, the retail space stocking system may comprise one or more of an unmanned motorized transport unit and associate user devices configured display stocking instructions to one or more associates. For example, an associate user device may instruct an associate to “restock 20 counts of C brand hazelnut coffee—32 oz from aisle 6, slot 5B of storage to aisle 3, space 6C of the retail space.” In some embodiments, the central computer system 1810 may determine items to move from the storage area to the retail space or vice versa based on the product allocation database 1805 and/or the current stock level of a plurality of items in the storage space. For example, if a store receives a shipment of brand E blue jeans in different sizes, the retail space stocking system 1840 may select a specified quantity of a subset of sizes to bring out to the retail space based on the product allocation database 1805 and keep the remaining jeans in the storage area. In some embodiments, the retail space stocking system 1840 may be configured to generally keep each item having a “display in retail space” item location indicator stocked in the retail space and prevent items having “storage area only” or “order only” item location indicators from being brought out to the retail space for display. In some embodiments, the central computer system 1810 and/or retail space stocking system 1840 may further be configured to bring items from the retail space to the storage room in the event that the product location indicator associated with the item changes from “display in retail space” to “storage area only.”

In some embodiments, one or more of the user interface device 1820, the item consolidation system 1830, and the retail space stocking system 1840 may comprise a processor-based control system comprising a control circuit configured to execute computer readable instructions stored on a memory. In some embodiments, the control systems of one or more of the user interface device 1820, the item consolidation system 1830, and the retail space stocking system 1840 may be implemented with the central computer system 1810. In some embodiments, the central computer system 1810 may further be coupled to a sales terminal system configured to process purchases of items available to customers in the retail space and/or a remote order fulfillment system. In some embodiments, orders processed through a sales terminal in the retail space may be used to update a store inventory database and keep the retail space stocked. In some embodiments, if a system receives an order that comprises at least one item not available in the retail space and the storage area, the central computer system 1810 may forward the order of the at least one item to a remote order fulfillment system to complete the order. The remote order fulfillment system may be associated with one or more distribution and/or fulfillment facilities equipped to deliver the ordered items to the customer.

In some embodiments, the product allocation database 1805 may be remote, local, and/or implemented with the memory 1814 of the central computer database. In some embodiments, one or more of the item consolidation system 1830, the retail space stocking system 1840, and the central computer system 1810 may further be coupled to one or more other databases such as an inventory database, a store layout database, a product characteristic database, a sales history database, a storage area location database, a task assignment database, a customer profiles database, etc. for performing one or more functions described herein.

Referring now to FIG. 19, a method for managing a store is shown. In some embodiments, the steps shown in FIG. 19 may be performed by a processor-based device such as the control circuit executing a set of computer readable instructions stored on a computer readable memory. In some embodiments, one or more steps of FIG. 19 may be performed by one or more of the control circuit 1812 of the central computer system 1810, a control circuit of the user interface device 1820, a control system of the item consolidation system 1830, and/or a control system of the retail space stocking system 1840 described with reference to FIG. 18 herein.

In some embodiments, prior to step 1901, the system may first determine item allocations for a plurality of unique product identifiers. In some embodiments, item location indicators may be determined and periodically updated based on one or more of: sales trend, sales history, store location demographic, product characteristics, current date, current season, and current weather. In some embodiments, location indicators may be updated at any frequency, including quarterly, monthly, weekly daily, or hourly. In some embodiments, the product location indicators may be determined based on comparing partiality vectors of the customers in the store location's market and vectorized product characteristics of a plurality of products offered for sale. For example, customer partiality vectors and vectorized product characteristics may be used to estimate the purchase rate of one or more products at the store location. Further details of customer partiality vectors for vectorized product characteristics are provided with reference to FIGS. 5-10 here.

In some embodiments, the item location indicators may be stored in a product allocation database 1805 described with reference to FIG. 18 or other similar systems. Unique product identifiers associated with items offered for sale may be separately assigned product location indicators by the system. In some embodiments, the unique product identifiers may comprise one or more of a Universal Product Code (UPC), a Barcode, a Radio Frequency Identification (RFID) code, a retailer assigned product identifier, a product name, a product descriptor, etc. In some embodiments, unique product identifiers associated with different color, size, flavor, and/or scent variants of a product type may be assigned different product location indicators. In some embodiments, the product location indicators for the one or more unique product identifiers may comprise a status selected from: display in retail space, hold in storage area only, and online order only. In some embodiments, an item assigned with a “display in retail space” location indicator may also have excess units stored in the storage area and be available for purchase through delivery orders. In some embodiments, an item assigned with a “hold in storage area only” location indicator may also be available for purchase through a delivery order.

In some embodiments, product location indicators associated with each unique product identifier may be updated independently of each other. For example, based on sales history, the system may change the allocation of a particular item from the storage area to the retail space or vice versa. In some embodiments, the allocation of an item may be determined based on the past or predicted sales rate of an item at the store location. For example, unique product identifiers with the highest range of sales rates may be assigned “display in the retail space” product location indicator, items with moderate sales rates may be assigned “storage area only” product location indicator, and items that are rarely purchased at a store location may be assigned “order only” product location indicator. In some embodiments, products may be compared to products in the same type or category to determine each product's allocation. In some embodiment, products assigned to each location indicator may be further based the available display space and/or storage space in the shopping facility. In some embodiments, product allocations may be determine based on store-wide sales rate and the retail space sections assigned to different product types and/or categories may be adjusted accordingly.

In some embodiments, the product location indicators for each unique product identifier may further specific the target quantities of each item at one or more locations. In some embodiments, the quantity of each item at one or more locations may be determine based on one or more of sales trend, sales history, store location demographic, product characteristics, promotions, current date, current season, and current weather. In some embodiments, the product location indicators assigned to products may different for different store locations.

In step 1901, a store management system associated with a store location determines whether to place an item in a retail space accessible to customer or in a storage area inaccessible to the customers based on a product location indicator associated with the item. In some embodiments, the product location indicator may be retrieved from a product allocation database such as the product allocation database 1805 described with reference to FIG. 18 herein. In some embodiments, the product location indicators of one or more unique product identifiers may each comprise a status selected from: display on retail space, hold in storage area only, and online order only. The retail space of a shopping facility may generally refer to the shopping floor of the shopping facility in which a customer can walk around and browse items on shelves and locations. Customer may generally retrieve items displayed in the retail space and proceed to a checkout terminal to make a purchase. The storage area of a shopping facility may generally refer to an area separated from the retail space and mainly accessible only to store associates/employees. Customers are generally not permitted to browse or retrieve items directly off the shelves in the storage area. In some embodiments, the system may further determine whether to bring an item to the retail space based on the current stock level of the item in the retail space. In some embodiments, the system may determine that an item should be brought out to the retail space for restocking if the displayed inventory level is low and the item has been assigned and “display in retail space” location indicator.

In step 1902, the system instructs the retail space stocking system to stock the item. Step 1902 may be based on the determination of step 1901. The retail space stocking system may comprise a system for stocking the retail space of the shopping facility that is accessible to customers shopping at the shopping facility. In some embodiments, the retail space stocking system may comprise one or more of an unmanned motorized transport unit and associate user devices configured display stocking instructions to one or more store associates. In some embodiments, the retail space stocking system may comprise the retail space stocking system 1840 described with reference to FIG. 18 herein. In some embodiments, the instructions may comprise information on items to restock, storage location of the items, display locations of the items, and/or the restocking quantities of the items. In some embodiments, in step 1901, the system may further cause an automated item consolidation system in the storage area to consolidate items needed for restocking the retail space from the storage area for the restocking system to bring out to the retail space.

In step 1903, the system receives an order from a customer. In some embodiments, the order may be received via a user interface device such as more or more of an ordering kiosk in the retail space, a portable device provided by the shopping facility, and/or a customer user device. The user interface device may provide a user interface to the customer for selecting one or more items to order. An in-store customer may browse a display module in a retail space. If an item is available in the retail space, the customer may retrieve the item off the shelf and carry the item to checkout. If the item the customer wish to purchase (e.g. size 6 Brand E blue jeans) is not made available to the customer in the retail space, the customer may use the user interface device order the item from the storage area of the shopping facility. In some embodiments, the system may associate a customer with the order by prompting the customer to log-in to the system, enter a customer ID, scan a customer loyalty card, scan a customer bank card, etc. The customer may then add items to their personal virtual shopping cart via the user interface displayed the user interface device. In some embodiments, the customer may scan a UPC or barcode of an item available in the retail space at the user interface, and the user interface may display related items to the customer. In some embodiments, the user interface may be configured to prioritize the display of items associated with the store section associated with the customer's current location and/or items currently available at the local store location. In some embodiments, the user interface device may allow customers to browse products associated with other sections of the store and/or products only available through online order. A customer may then select one or more products to add to a virtual shopping cart associated with the customer. In some embodiments, the virtual shopping car may include items the customer elected to retrieve from the retail space, receive from the storage area, and/or order for delivery or pick at a future date.

In some embodiments, the customer user interface provided by the system may indicate whether each item is available in the retail space, available in the storage area of the shopping facility, and/or available via online order only. In some embodiments, the available purchase method may be determined based on the product location indicator stored in the product allocation database and/or the item's current availability in the retail space and/or the storage space of the shopping location in which the user interface device and/or customer is located. In some embodiments, the system may provide the customer with the option to receive a products available on the retail space from the storage space if the customer prefers to not carry the product around the store while he/she shops. In some embodiments, the system may provide the customer with the option to deliver a product available in the retail space and/or in the storage area of the shopping space to a customer location if the customer prefers to not transport the products themselves. In some embodiments, the user interface may provide one or more purchase methods for one or more items in a customer's virtual shopping cart. In some embodiments, one or more methods may be selected individually for each items in the shopping cart and/or for the entire shopping cart. In some embodiments, the customer may purchase items accessible to the customers in the retail space through conventional methods without adding the item to the virtual shopping cart via the user interface device.

In the event that the order received from the customer in step 1903 comprises items to be provided from the storage area, the system may proceed to step 1904 and cause the item consolidation system to the retrieve the items for the customer. Items to be provided form the storage area may comprise one or more of items with a “storage area only” or “display in retail space” location indicators. In some embodiments, an item with a “display in retail space” location indicator may be provided from the storage area if the item is currently out of stock in the retail space and/or if the customer elects to receive the item from the storage area instead. In some embodiments, step 1904 may be performed as a customer adds items to his/her virtual shopping cart. For example, each item may be added to a customer tote as they are added to the customer's virtual shopping cart. In some embodiments, step 1904 may be performed only when the customer indicates that he/she is ready to check out and purchase the items. In some embodiments, items provided from the storage area may be prepared for in-store pickup by the customer or for delivery to a customer location. In some embodiments, the use interface may further be configured to provide an updated status of the item consolidation process to the customer. For example, the user interface may show which items has been added to the customer tote container and/or whether the order is ready for pickup. In some embodiments, the user interface may further be configured to receive and process payments for items ordered by the customer. In some embodiments, a customer may pay for the items ordered from the storage area of the shopping facility via a sales terminal when or after they pick up the items consolidated by the item consolidation system.

The item consolidation system may comprise a consolidation system in the storage area of a shopping facility configured to consolidate items for customer retrieval. In some embodiments, the item consolidation system may comprise mechanisms such as conveyor systems, mechanical arms, and motorized movable units for moving items from storage spaces to an item collection area for customer retrieval. In some embodiments, the item consolidation system may comprise one or more associate user interface devices configured to display consolidation instructions to one or more store associates. In some embodiments, if an item is only available in the retail space, the system may instruction an associate and/or movable transport unit to bring the item from the retail space to the storage space for consolidation. In some embodiments, the item consolidation system may be configured to place a plurality of items in a container for customer pickup or delivery based on customer orders. For example, items may be consolidated into a pick-up tote, a shipment box, a delivery cooler, etc. for the customer. In some embodiments, the items consolidated by the item consolidation system may be configured to be picked up by the customer, delivery form the shopping facility to the customer location, and/or shipped via a third party delivery service provider. In some embodiments, after step 1904, the customer may proceed to a pick-up station to retrieve the items they ordered from the storage area of the shopping facility, proceed to their vehicle and receive a curb-side delivery, and/or leave the store and wait for home delivery.

In some embodiments, multiple instances of steps 1903 and 1904 may occur simultaneously for a plurality of customers. In some embodiments, the system may be configured to store a virtual shopping cart for a plurality of customers and fullfill the purchase orders through the item consolidation system.

In some embodiments, after step 1903, if one or more items selected by a customer contains online order only items, the system may forward the order to a remote distribution center and/or online order fulfillment system to complete the order.

Next referring to FIG. 20, an illustration of a display module in a retail space of a shopping facility is shown. The display module 2000 may be comprise one or more shelves, pegs, racks, and other support structures for displaying a plurality of items offered for sale in a retail space. In some embodiments, the display module 2000 may correspond to one side of an aisle on the shopping floor. The items displayed on the display module 2000 may be determined based on the product location indicator associated with unique product identifiers for each item described with reference to FIGS. 18 and 19 herein. In some embodiments, the maximum/target quantities of each item displayed on the display module may further be specified by the product location indicator.

The display module 2000 may comprise an ordering kiosk 2010. The ordering kiosk 2010 may comprise a user interface device such as a display screen, a touch screen, a keypad, a microphone, a speaker, one or more buttons, and the like. The ordering kiosk 2010 may comprise a processor-based device with a control circuit, a memory, and a communication device configured to communicate with a central computer system. In some embodiments, the ordering kiosk may display a plurality of items for a customer to request/order. In some embodiments, the display module 2000 may be associated with a product category or type (e.g. canned food, species, cleaning supply, pasta, etc.) and the kiosk may be configured to initially display other products of the same category or type that are not stocked at the display module 2000. For example, one flavor of brand C coffee may be made available at the display module 2000 and the ordering kiosk 2010 may display additional flavors of brand C coffee. In some embodiments, the kiosk may further allow a customer to browse through all items offered for sale by the retail entity via a search and/or category user interface. In some embodiments, the kiosk may allow customers to filter the products to see only products available locally at the shopping facility. In some embodiments, the kiosk may further comprise a scanner or reader for reading product identifications and customer identifications. In some embodiments, a customer may use the ordering kiosk 2010 to order products from the storage area of the shopping facility and/or a remote distribution center. In some embodiments, the customer may select a purchase method for one or more items he/she orders. For example, the customer may request that the item be consolidated for in-store pickup, be brought out for curbside loading, or be delivered to a customer specified address such as the customer's home. In some embodiments, the ordering kiosk 2010 may comprise the user interface device 1820 described with reference to FIG. 18 herein or other similar devices. The placement of the ordering kiosk 2010 in FIG. 20 is shown as an example only. The ordering kiosk 2010 may be placed at any part of the display module 2000 or other locations in the retail space without departing from the spirit of the present disclosure.

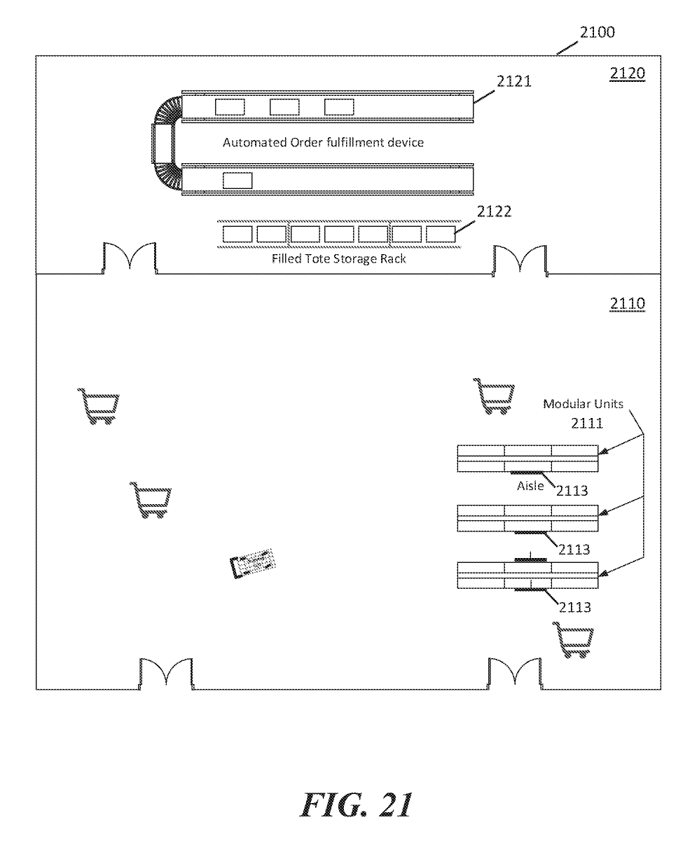

Next referring to FIG. 21, and illustration of a shopping facility is shown. The shopping facility 2100 includes a storage area 2120 and a retail space 2110. The retail space 2110 may comprise a plurality of modular units 2111 for displaying a plurality of items such that the items are available for handling and purchase by customers. The modular units 2111 may be arranged in a numbers of aisles through which the customers can browse and select items they wish to purchase off the modular units 2111. In some embodiments, the modular units 2111 may comprise the display module 2000 of FIG. 20 or other similar apparatuses. The modular units 2111 may include ordering kiosks 2113 for customers to order items from the storage area 2120 and/or a remote distribution center. In some embodiments, the ordering kiosk 2113 may comprise the user interface device 1820 of FIG. 18, the ordering kiosk 2010 of FIG. 20, or other similar devices.

The storage area 2120 of the shopping facility 2100 may generally be an area sectioned off from the retail space 2110 by walls or other barriers. Customers may generally be prevented from entering the storage area 2120. The storage area 2120 includes an automated order fulfillment device 2121 and a filled tote storage rack 2122. The automated order fulfillment device 2121 may be configured to gather items ordered by customers from item storage locations and place them into totes or other types of containers assigned to customers. The filled totes may then be transferred to the filled tote storage rack 2122 for customer retrieval. In some embodiments, the automated order fulfillment device 2121 may comprise the item consolidation system 1830 described with reference to FIG. 18 herein. In some embodiments, the shopping facility 2100 may further comprise one or more in-store pick-up locations. The shopping locations may be located in the retail space 2110 and/or at the wall separating the retail space 2110 and the storage area 2120. In some embodiments, pick-up locations may comprise a plurality of pick-up stations. When an order is ready for pick-up, the system may further be configured communicate the location the customer container (e.g. pick-up station number) to the customer.

The configuration and proportions of the shopping facility 2100 in FIG. 21 are provided as an illustration only. A shopping facility may comprise a retail space 2110 separated from a storage area 2120 having an automated order fulfillment device 2121 in any configuration without departing from the spirit of the present disclosure.

In some embodiments, the systems and methods described herein provides a hybrid “store as a showroom” store format. Such hybrid stores may include (1) a “front of the store” that stocks the most popular (e.g. top 20% of sales) products and (2) a backroom that stocks the less popular (e.g. top 20%-80% of sales) products. The remaining products may be stocked at a remote distribution center (DC), a regional warehouse, or not at all. The front of the store may include modular product display units (modular units) that form aisles. The display units may display and store the most commonly purchased products such that customers can browse and pick items for purchase from the modular units. In some embodiments, a modular unit may also include a kiosk (e.g. a touch screen kiosk) that allows customers to browse, view, select, and/or order items in the backroom (e.g. the next 60% in popularity) or in the distribution center (e.g. the last 20% in popularity). In some embodiments, customer selected items in the backroom may be prefilled into container for customer pickup. In some embodiments, items in the distribution center may be shipped to the customer's home or shipped to the store for customer pickup at a later time. With the systems and methods described herein, a store does not need to dedicate modular units to house and display the less popular products, thereby reducing the store floor space requirement while still offering the customer the same product options.

In some embodiments, an aggregate of regional customer value proposition vectors may be used to determine what products should be stocked in the front of the store, the backroom, and the distribution center for that given region or location. Generally, a customer's value proposition vectors represents what customer's value in products. For example, a customer may tend to value products that are: inexpensive compared to other similar products; high quality compared to other similar products; healthy/low fat/low sodium/high fiber/etc. relative to other similar products; made in the U.S. as opposed to other products; made from organic materials/ingredients compared to other similar products; sold in larger quantities than other similar products; made by companies that support certain political/environmental interests as opposed to other products; and so on. These vectors comprise a direction and a magnitude. In some embodiments, vectors may represent how strongly a given consumer values products that are inexpensive, healthy/low fat/low sodium/high fiber, made in the U.S., etc. The value proposition vectors of customers in a given region may be used to determine what products should be stocked in the front of the store, the backroom, and the DC for a given region.

In some embodiments, the systems and methods described herein may result in a significant reduction in the square footage of the brick-n-mortar store while providing a significant degree of flexibility and adaptability as to inventory management. The store format described herein may also greatly reduce shrinkage and permit more accurate inventory tracking. The savings created by reduced shrinkage and inventory accuracy may further offset costs of implementation. The store format described herein modifies the conventional back of the store areas to be highly adaptable and flexible fulfillment centers. The system also provides the customer with options to carry items home with them, ship items from the store to the customer's home (or locker), or ship the items to the customer's home (or locker) immediately or at a later specified time. The system may further leverage aggregated customer data to vectorize the likes/dislikes of the customer to permit highly granular predictive shipping and inventory management. The allocation of products and categories may further be dynamically refined and updated based on periodically updated customer and product vectors.

Based upon an analysis of strengths of the customer preferences for selected ones of the customer partiality vectors and at the central processing center, a trending value is determined. At the central processing center and based on the trending value, a recommendation message is formed and transmitted to the receiver circuit identifying a product modification to the product. The product modification, when made, is effective to modify a strength of one of vectorized product characterizations of the product. The modified strength increases an alignment between at least one of the vectorized product characterizations of the product and the trending values such that the increased alignment is effective to maximize customer purchases of the product.

These teachings can be leveraged and utilized in still other ways as well. Consider a household where a wife prepares meals for her husband. The wife has knowledge of the items that her husband likes to eat as well as his values such as eating healthy, having an exciting taste profile, a preference for comfort foods, or a desire for organic foods to mention a few examples. The husband's values can be represented as customer partiality (value) vectors. When the wife chooses a recipe, she is aligning her decision around the husband's values. She is not trying to predict the meal preference of the husband on any given day.

To take one example, the husband might have a preference on a given day for Chinese food, but his wife has prepared Mexican food. When he gets home, his preference will change when he smells, sees, and hears the food preparation. Even if his preference for a particular type of meal or cuisine changes, his values remain the same. His wife is confident that he will choose to eat what she has prepared because she knows that it will be healthy, has an exciting taste profile and communicates a feeling of comfort. In other words, the value proposition of the product (the meal) is aligned with the values of the customer (the husband's values).

As the husband's value of eating healthy trends stronger, the recipe choices will move in that direction. For example, the wife may purchase a very expensive healthy ingredient that a recipe calls for and which the husband might still choose to eat, but he may decide that the meal was not good enough to justify the cost. The wife then knows that at this time, the trending value of eating healthy is not strong enough to overcome the high cost of the ingredients. The wife is constantly adjusting the alignment of the value proposition of a recipe against her husband's culinary values to provide the best recipe selection that her husband will always prefer.

Applying this example across multiple customers, (1) if the values of customers (represented by customer partiality vectors) are known, (2) if a trending value for multiple customers is determined from an aggregate of the customer partiality vectors, and (3) if the product's value proposition (represented by the vectorized product characterizations) is also known, then an alignment between the trending values and the value proposition can be maximized. More specifically, an alignment between the two vector quantities (i.e., the trending values and vectorized product characterizations) can be maximized or achieved such that when a customer perceives that the alignment is satisfactory, the customer will select or purchase the product.

With these examples in mind and in some of these embodiments, a system that is configured to maximize customer purchases of a product at a retail store includes a receiver circuit, a communication network, a database, and a control circuit. The receiver circuit is disposed at a retail store and the communication network is coupled to the receiver circuit.

The database includes a plurality of customer partiality vectors. Each of the customer partiality vectors comprises a customer preference for a customer that is programmatically linked to a strength of the customer preference. The database also includes a plurality of vectorized product characterizations. Each of the vectorized product characterizations comprises a product characteristic that is programmatically linked to a strength of the product characteristic.

The control circuit is coupled to the database and the communication network, and disposed at a central processing center. The control circuit is configured to, based upon an analysis of strengths of the customer preferences for selected ones of the customer partiality vectors, determine one or more trending values. Based on the trending values, the control circuit is configured to determine at least one product modification and transmit the product modification in a recommendation message to the receiver circuit. The product modification, when made by the retail store, is effective to increase an alignment between at least one of the vectorized product characterizations of the product and the trending values such that customer purchases of the product are maximized.

In aspects, the product modification is effective to adjust a strength of one of the vectorized product characterizations of the product. In other examples, the trending value is the customer preference having the greatest change over a predetermined time period amongst the customer partiality vectors. In still other examples, the trending value is the customer preference having the greatest strength amongst the customer partiality vectors.

In aspects, the recommendation message specifies an adjustment to the sourcing of the product. In other aspects, the recommendation message specifies an adjustment to the advertising or marketing for the product. In yet other aspects, the recommendation message specifies an adjustment be made to the physical characteristics of the product.

In some examples, the customer preference relates to a color, size, weight, source, price, or associated promotion associated with the product. In other examples, the product characteristic relates to a color, size, weight, source, price, or associated promotion associated with the product.

In still other aspects, the control circuit is configured to select a subset of the customer partiality vectors. For example, partiality vectors of customers living in certain geographic area can be selected.

In others of these embodiments, at a central processing center, a plurality of customer partiality vectors are received from a database. Each of the customer partiality vectors comprises a customer preference of a customer that is programmatically linked to a strength of the customer preference.

At the central processing center, a plurality of vectorized product characterizations are also received from the database. Each of the vectorized product characterizations comprises a product characteristic programmatically linked to a strength of the product characteristic.

Based upon an analysis of strengths of the customer preferences for selected ones of the customer partiality vectors and at the central processing center, a trending value is determined. At the central processing center and based on the trending value, a recommendation message is formed and transmitted to the receiver circuit identifying a product modification to the product. The product modification, when made, is effective to modify a strength of one of the vectorized product characterizations of the product. The modified strength increases an alignment between at least one of the vectorized product characterizations of the product and the trending values such that the increased alignment is effective to maximize customer purchases of the product.

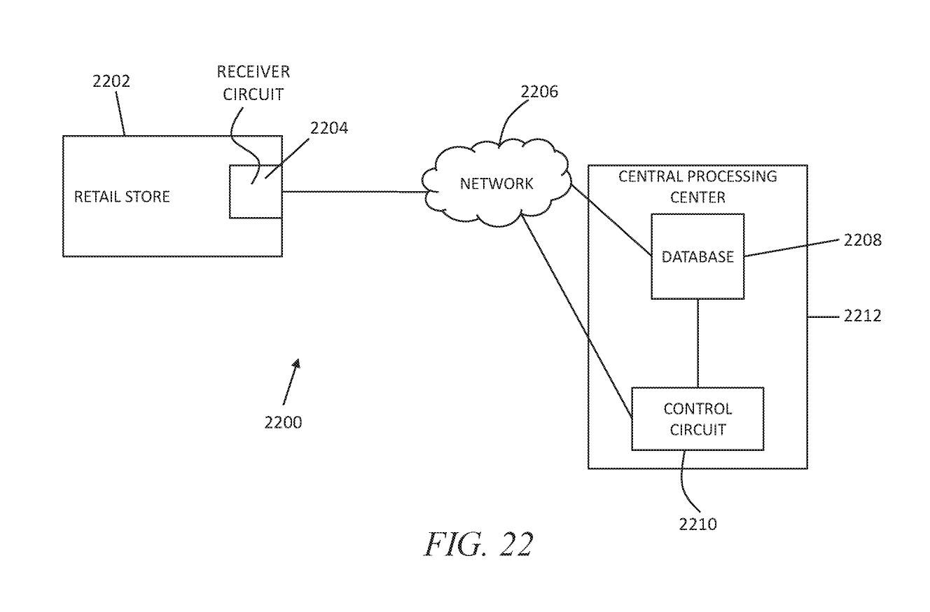

Referring now to FIG. 22, one example of a system 2200 that is configured to maximize customer purchases of a product at a retail store 2202 includes a receiver circuit 2204, a communication network 2206, a database 2208, and a control circuit 2210. The receiver circuit 2204 is disposed at a retail store 2202 and the communication network 2206 is coupled to the receiver circuit 2204. It will be appreciated that many of the examples described relate to physical products, that these examples also apply to services provided (e.g., actions, work, help, aid, or assistance).

The retail store 2202 may be any type of retail store, for example, a discount center, a grocery store, a department store, or a hardware store to mention a few examples. The receiver circuit 2204 may be any combination of hardware or software elements that receive information from the communication network 2206. In some examples, the receiver circuit 2206 may be replaced with a transceiver circuit, which is configured to both transmit and receive information from/to the communication network 2206.

The communication network 2206 is any type of communication network. In examples, the communication network may be the cloud network, or the Internet. The communications network 2206 may include routers, gateways, and servers to mention a few examples of devices that can form or be utilized in the network 2206. The communication network 2206 may also be combinations of various types of networks.

The database 2208 includes a plurality of customer partiality vectors. Each of the customer partiality vectors comprises a customer preference for a customer that is programmatically linked to a strength of the customer preference. The database 2208 also includes a plurality of vectorized product characterizations. Each of the vectorized product characterizations comprises a product characteristic that is programmatically linked to a strength of the product characteristic.

The control circuit 2210 is coupled to the database and the communication network, and disposed at a central processing center 2212. The database 2208 may also be disposed at the central processing center 2212, but, in aspects, may be disposed at a different location.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 2210 may be configured (for example, by using corresponding programming stored in a memory as will be well understood by those skilled in the art) to carry out one or more of the steps, actions, and/or functions described herein.

The control circuit 2210 is configured to, based upon an analysis of strengths of the customer preferences for selected ones of the customer partiality vectors, determine one or more trending values. Based on the trending values, the control circuit 2210 is configured to determine at least one product modification and transmit the modification(s) in a recommendation message to the receiver circuit 2204. The product modification, when made by the retail store 2202, is effective to increase an alignment between at least one of the vectorized product characterizations of the product and the trending values such that customer purchases of the product are maximized.

In aspects, the product modification is effective to adjust a strength of one of the vectorized product characterizations of the product. In other examples, the trending value is the customer preference having the greatest change over a predetermined time period amongst the customer partiality vectors. In still other examples, the trending value is the customer preference having the greatest strength amongst the customer partiality vectors.

In aspects, the recommendation message specifies an adjustment to the sourcing of the product. In other aspects, the recommendation message specifies an adjustment to the advertising or marketing for the product. In yet other aspects, the recommendation message specifies an adjustment be made to the physical characteristics of the product.

In some examples, the customer preference relates to a color, size, weight, source, price, or associated promotion associated with the product. In other examples, the product characteristic relates to a color, size, weight, source, price, or associated promotion associated with the product.

In still other aspects, the control circuit 2210 is configured to select a subset of the customer partiality vectors. For example, partiality vectors of customers living in certain geographic areas, customers with certain income levels, or customers with certain educational levels can be selected. Other examples are possible.

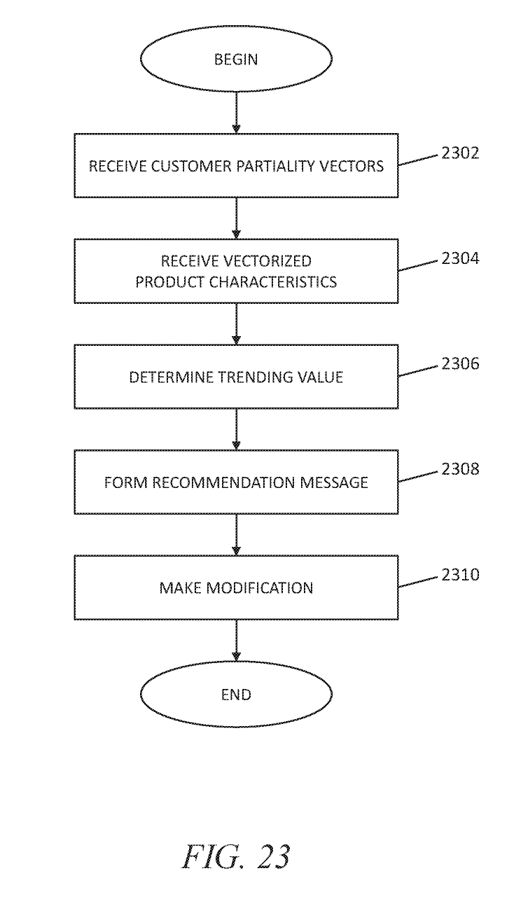

Referring now to FIG. 23, one example of an approach for optimizing customer product purchases is described. At step 2302 and at a central processing center, a plurality of customer partiality vectors are received from a database. Each of the customer partiality vectors comprises a customer preference of a customer that is programmatically linked to a strength of the customer preference. The partiality vectors may be stored as any type of data structure. In one example, a customer partiality vector may relate to the price of a product. An integer value may represent the strength of the value or the angle of the vector may represent the strength.

At step 2304 and at the central processing center, a plurality of vectorized product characterizations are also received from the database. Each of the vectorized product characterizations comprises a product characteristic programmatically linked to a strength of the product characteristic. The vectorized product characterizations may be stored as any type of data structure. In one example, a vectorized product characterization may relate to the price of a product. An integer value may represent the strength of the value or the angle of the vectorized product characterization may represent the strength.

At step 2306, based upon an analysis of strengths of the customer preferences for selected ones of the customer partiality vectors and at the central processing center, a trending value is determined. For example, the strengths of the customer partiality vectors may be summed, and divided by the number of customer partiality vectors. If the result exceeds a predetermined threshold, then the value may be determined to be a trending value.

At step 2308, at the central processing center and based on the trending value or trending values, a recommendation message is formed and transmitted to the receiver circuit identifying a product modification to the product. Different approaches can be utilized to determine a particular recommendation. In one approach, if one trending value is determined, a look-up table may be used to obtain a predetermined recommendation. In still other approaches, other customer values may also be analyzed. For instance, if economical pricing were determined (from an analysis of the customer partiality vectors) to be an important or trending value (e.g., the average strength were above a predetermined threshold), then the recommendation may be modified to take these other customer values into account.

In other approaches where multiple trending values are determined, the trending values are balanced such that multiple recommendations are possible. For instance, if both economical price and organic product sourcing are trending, then a recommendation of obtaining a moderately priced, organically-sourced product may be made.

Once received, the retail store may, at step 2310, make a modification or modifications to the product suggested by the recommendation message. In examples, the modification may be changing the size, weight, sourcing, dimensions, composition, color, or some physical characteristic of the product. In other examples, the price of the product may be changed. In still other examples, modification to advertisements relating to the product may also be made. In yet other examples, the recommendation message may instigate an automatic change or process that implements the product modification.

The product modification, when made, is effective to modify a strength of one of the vectorized product characterizations of the product. The modified strength increases an alignment between at least one of the vectorized product characterizations of the product and the trending values such that the increased alignment maximizes customer purchases of the product.

In aspects, vector dot product calculations can serve to help identify whether the product aligns with the trending values. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

As mentioned above, this operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. Accordingly, when using vector angles to impart this magnitude information, the vector dot product operation provides a simple and convenient way to determine proximity between a particular customer trending values and the performance/properties of a particular product to thereby greatly facilitate identifying a best product amongst a plurality of candidate products. When a customer perceives that the alignment is (to the customer) satisfactory, then the customer may purchase the product.

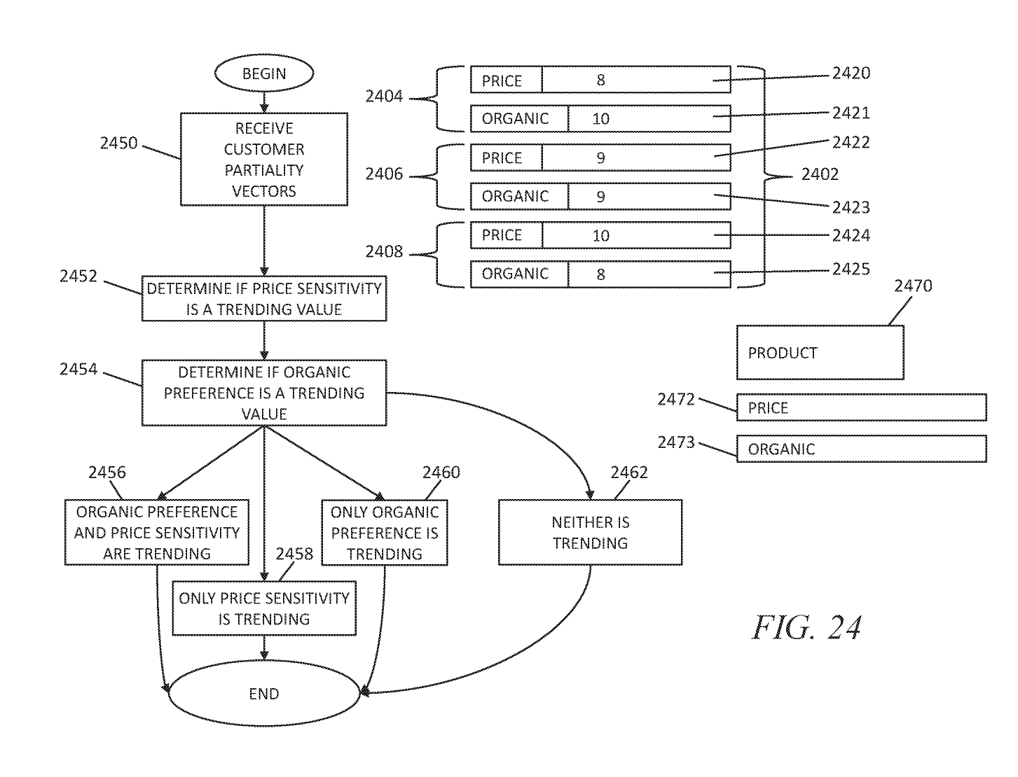

Referring now to FIG. 24, one example of an approach for optimizing customer purchases of a product 2470 is described. It will be appreciated that the example of FIG. 24 is one example of a process whereby trending values are analyzed to determine an appropriate recommendation to send in a recommendation message to a retail store. Other examples are possible.

At step 2450, customer partiality vectors 2402 are received. In this example, groupings 2404, 2406, and 2408 are from or associated with three different customers. Grouping 2404 (including vectors 2420 and 2421) is from or associated with a first customer. Grouping 2406 (including vectors 2422 and 2423) is from or associated with a second customer. Grouping 2408 (including vectors 2424 and 2425) is from or associated with a third customer.

Each of the customer partiality vectors has a customer value (e.g., “price sensitivity” or “organic preference”) and a strength (represented by an integer). Vectors 2420, 2422, and 2424 relate to the price sensitivity of a particular customer. Vectors 2421, 2423, and 2425 relate to the organic preference of a particular customer. The angles may all be 0 degrees in this example. In other aspects, the angle may represent the strength and the vectors would all have the same strength or magnitude.

At steps 2452 (for organic preference) and 2454 (for price sensitivity), it is determined whether the particular customer value is a trending value. In aspects, this is accomplished by analyzing the customer partiality vectors 2402.

With step 2452, customer partiality vectors 2421, 2423, and 2425 are examined and have strengths of 8, 9, and 10. The sum of strengths are added together, and then divided by the number of vectors to obtain an average. If the average is above a first predetermined threshold, then the value is considered to be a trending value. In this example, the values are added together (8+9+10=27). The sum is divided by 3 (27/3=9). If the first threshold (relating to organic preference) has been set to be 8, then organic preference is determined to be a trending value because 9 is greater than 8. The first threshold can be adjusted by a user as needed or required.

A determination as to whether price sensitivity is a trending value is made at step 1654 with an examination of the vectors 2420, 2422, and 2424. In this case, the strengths of these vectors are 10, 9, and 8. The sum of strengths are added together, and then divided by the number of vectors to obtain an average. If the average is above a second predetermined threshold, then the value is considered to be a trending value. In this example, the strengths are added together (10+9+8=27), and then the sum is divided by 3 to obtain a result (27/3=9). If the second threshold (relating to price sensitivity) has been set to be 8, then price sensitivity is determined to be a trending value because 9 is greater than 8. If the first threshold (relating to organic preference) has been set to be 8, then organic preference is determined to be a trending value because 9 is greater than 8. The second threshold can be adjusted by a user as needed or required.

A recommendation message is then formed. Generally speaking, the recommendation message offers suggestions to the retail store that effectively increase an alignment between the trending value(s) and the value proposition (vectorized product characterizations) of selected products at the store.

In the example of FIG. 24, if both values (organic preference and price sensitivity) are trending, then step 2456 is executed. This step determines a recommendation that balances price and organic preference considerations. If step 2456 is reached, then the recommendation may be to find organic sources for the product 2470, but to limit the price of the product 2470 to a specific amount. Other examples are possible.

If only price sensitivity is trending, then step 2458 is executed. In examples, the recommendation at step 2458 may be to lower the price to a particular value (e.g., where the value is determined by customer surveys). Other examples are possible.

If only organic preference is trending, then step 2460 is executed. In examples, the recommendation at step 2460 may be to organically source a product and then advertise the sourcing to customers. Other examples are possible.

The product 2470 at the store has a first vectorized product characterization 2472 (relating to price) and a second vectorized product characterization 2473 (relating to the organic nature of the product). When the recommendations are followed, the result is to change the values and/or angles of the first vectorized product characterization 2472 and the second vectorized product characterization 2473 to better align with the trending values such that customer purchases of the product are maximized. In aspects, the strengths and/or directions of the first vectorized product characterization 2472 and the second vectorized product characterization 2473 are adjusted so as to be in closer alignment to the trending values.

In this example, the product 2470 may be coffee and step 2456 is executed since both price sensitivity and organic preference are trending values. The recommendation message formed at step 2456 offers a specific recommendation to increase the organic sourcing of the coffee, but without over-pricing the item. In so doing, customer purchases of the coffee are maximized.

In another example, a further recommendation is to advertise that the coffee is both inexpensive and organically sourced. As a result of the retail store following the recommendations, the alignment between the two vector quantities (i.e., the trending values of both organic preference and price sensitivity, and the vectorized product characterizations 2472, 2473) is maximized or achieved such that when a customer perceives that the alignment is satisfactory, the customer will select or purchase the coffee.

On a given day, a customer may enter the store to purchase a different product (e.g., hamburger). However, the customer upon entering the store may notice coffee being advertised. When the customer enters the store, his or her product-type preference will change (from hamburger to coffee) when the customer sees the advertisement for the coffee. Even if the preference for a particular product-type of changes, his or her values remain the same. The store can be confident that the customer will choose a product (e.g., the coffee) with the right mix of price and organic sourcing so that the customer has the highest likelihood of purchasing the product (e.g., the coffee). In other words, the value proposition of the product (e.g., the coffee) is aligned with the trending values of the customers.

As the customers' values change, the product choices, characteristics, pricing, and/or advertising will move in that direction. For example, pricing sensitivity may drop in importance while organic preference remains the same (or grows stronger) so that more expensive sources or organic food can be used or sourced. The retail store is constantly adjusting the alignment of the value proposition of its products against customer values (e.g., trending values) so as to provide the best chance a customer will purchase the product. Put another way, trending values change over time as some values become trending and other values are no longer trending.

In other aspects, a subset of the customer partiality vectors may be determined and only customer partiality vectors from these customers considered in determining trending values. For example, partiality vectors of customers living in certain geographic areas, customers with certain income levels, or customers with certain educational levels can be selected. Other examples are possible. The number of customers in the subset may be any integer 1 or greater.

In some embodiments, a system that is configured to maximize customer purchases of a product at a retail store. The system comprises a receiver circuit at a retail store, a communication network coupled to the receiver circuit, a database including a plurality of customer partiality vectors, wherein each of the customer partiality vectors comprises a customer preference for a customer that is programmatically linked to a strength of the customer preference, the database also including a plurality of vectorized product characterizations, wherein each of the vectorized product characterizations comprises a product characteristic that is programmatically linked to a strength of the product characteristic, a control circuit coupled to the database and the communication network, the control circuit being disposed at a central processing center, the control circuit configured to: based upon an analysis of strengths of the customer preferences for selected ones of the customer partiality vectors, determine one or more trending values, based on the trending values, determine at least one product modification and transmit the at least one product modification in a recommendation message to the receiver circuit, the at least one product modification, when made by the retail store, being effective to increase an alignment between at least one of the vectorized product characterizations of the product and the trending values such that customer purchases of the product are maximized.

In some embodiments, the at least one product modification is effective to adjust a strength of one of the vectorized product characterizations of the product. In some embodiments, the trending value is the customer preference having the greatest change over a predetermined time period amongst the customer partiality vectors. In some embodiments, the trending value is the customer preference having the greatest strength amongst the customer partiality vectors. In some embodiments, the recommendation message specifies an adjustment to the sourcing of the product. In some embodiments, the recommendation message specifies an adjustment to the advertising or marketing for the product. In some embodiments, the recommendation message specifies an adjustment be made to the physical characteristics of the product. In some embodiments, the customer preference relates to a color, size, weight, source, price, or associated promotion associated with the product. In some embodiments, the product characteristic relates to a color, size, weight, source, price, or associated promotion associated with the product. In some embodiments, the control circuit is configured to select a subset of the customer partiality vectors.

In some embodiments, a method comprises, at a central processing center, receiving a plurality of customer partiality vectors from a database, wherein each of the customer partiality vectors comprises a customer preference of a customer that is programmatically linked to a strength of the customer preference, at the central processing center, receiving a plurality of vectorized product characterizations from the database, wherein each of the vectorized product characterizations comprises a product characteristic programmatically linked to a strength of the product characteristic, based upon an analysis of strengths of the customer preferences for selected ones of the customer partiality vectors and at the central processing center, determining a trending value, at the central processing center and based on the trending value, forming and transmitting a recommendation message to the receiver circuit identifying a product modification to the product, the product modification, when made, being effective to modify a strength of one of the vectorized product characterizations of the product, the modified strength increasing an alignment between at least one of the vectorized product characterizations of the product and the trending values such that the increased alignment is effective to maximize customer purchases of the product.

In some embodiments, the at least one product modification is effective to adjust a strength of one of the vectorized product characterizations of the product. In some embodiments, determining the trending value comprises selecting the customer preference having the greatest change over a predetermined time period amongst the customer partiality vectors. In some embodiments, determining the trending value comprises selecting the customer preference having the greatest strength amongst the customer partiality vectors. In some embodiments, the recommendation message specifies an adjustment to the sourcing of the product. In some embodiments, the recommendation message advises adjusting the advertising or marketing for the product. In some embodiments, the recommendation message advises adjusting the physical characteristics of the product. In some embodiments, the customer preference relates to a color, size, weight, source, price, or associated promotion associated with the product. In some embodiments, the product characteristic relates to a color, size, weight, source, price, or associated promotion associated with the product. In some embodiments, the method further comprises selecting a subset of the customer partiality vectors.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; and 62/548,503 filed Aug. 22, 2017.

What is claimed is:

1. A store management system comprising:
a product allocation database storing product location indicators for one or more unique product identifiers associated with items offered for sale;
an item consolidation system;
a retail space stocking system; and
a control circuit coupled to the product allocation database, the item consolidation system, and the retail space stocking system, the control circuit being configured to:
determine whether to place an item on a retail space accessible to customers or in a storage area inaccessible to the customers based on a product location indicator associated with the item;
instruct the retail space stocking system to stock the retail space based on the product location indicator of a plurality of items;
receive, via a user interface, an order from an in-store customer including a plurality of selected items that comprises items not available in the retail space; and
cause the item consolidation system to retrieve at least some of the items not available on the retail space from the storage area for the in-store customer.

2. The system of claim 1, wherein the product location indicators in the product allocation database are dynamically updated based on one or more of: sales trend, sales history, store location demographic, promotions, product characteristics, current date, current season, and current weather.

3. The system of claim 1, wherein the product location indicators for the one or more unique product identifiers each comprises a status selected from: display in retail space, hold in storage area only, and online order only.

4. The system of claim 1, wherein unique product identifiers associated with different color, size, flavor, and/or scent variants of a product type may be assigned different product location indicators.

5. The system of claim 1, wherein the item consolidation system is configured to place the plurality of items in a container for customer pickup or delivery based on customer selection.

6. The system of claim 1, wherein the item consolidation system comprises an automated conveyor system.

7. The system of claim 1, further comprising a sales terminal system configured to process purchases of items available to customers in the retail space.

8. The system of claim 1, wherein, in an event that the order comprises at least one item not available in the retail space and the storage area, forwarding the order of the at least one item to a remote order fulfillment system.

9. The system of claim 1, further comprising: a customization system configured to customize one or more items based on selections from a customer prior to providing the item to the customer via the item consolidation system.

10. The system of claim 9, wherein customization comprises one or more of: printing, 3D printing, engraving, and tailoring.

11. A method for store management comprising:
determining, with a control circuit, whether to place an item on a retail space accessible to customers or in a storage area inaccessible to the customers based on a product location indicator associated with the item stored in a product allocation database storing product location indicators for one or more unique product identifiers associated with items offered for sale;
instructing a retail space stocking system to stock the retail space based on the product location indicators of a plurality of items;
receiving, via a user interface, an order from an in-store customer including a plurality of selected items that comprises items not available in the retail space; and
causing an item consolidation system to retrieve at least some of the items not available on the retail space from the storage area for the in-store customer.

12. The method of claim 11, wherein the product location indicators in the product allocation database are dynamically updated based on one or more of: sales trend, sales history, store location demographic, promotions, product characteristics, current date, current season, and current weather.

13. The method of claim 11, wherein the product location indicators for the one or more unique product identifiers comprises a status selected from: display in retail space, hold in storage area only, and online order only.

14. The method of claim 11, wherein unique product identifiers associated with different color, size, flavor, and/or scent variants of a product type may be assigned different product location indicators.

15. The method of claim 11, wherein the item consolidation system is configured to place the plurality of items in a container for customer pickup or delivery based on customer selection.

16. The method of claim 11, wherein the item consolidation system comprises an automated conveyor system.

17. The method of claim 11, further processing purchases of items available to customers on the retail space via a sales terminal system.

18. The method of claim 11, wherein, in an event, that the order comprises at least one item not available in the retail space and the storage area, forwarding the order of the at least one item to a remote order fulfillment system.

19. The method of claim 11, further comprising: customizing, via a customization system, one or more items based on selections from the customer prior to providing the item to the customer via the item consolidation system.

20. An apparatus for store management comprising:
a non-transitory storage medium storing a set of computer readable instructions; and
a control circuit configured to execute the set of computer readable instructions which causes to the control circuit to:
determine whether to place an item on a retail space accessible to customers or in a storage area inaccessible to the customers based on a product location indicator associated with the item stored in a product allocation database storing product location indicators for one or more unique product identifiers associated with items offered for sale;
instruct a retail space stocking system to stock the retail space based on the product location indicators of a plurality of items;
receive, via a user interface, an order from an in-store customer including a plurality of selected items that comprises items not available in the retail space; and
cause an item consolidation system to retrieve at least some of the items not available on the retail space from the storage area for the in-store customer.
